(19) United States
(12) Patent Application Publication
(10) Pub. No.: US 2017/0357993 A1
(43) Pub. Date: Dec. 14, 2017

(54) APPARATUS AND PROCESS FOR DISCOUNTED OFFERS

(71) Applicant: MARCUS LAWRENCE THUESEN, Katy, TX (US)

(72) Inventor: MARCUS LAWRENCE THUESEN, Katy, TX (US)

(21) Appl. No.: 15/178,185

(22) Filed: Jun. 9, 2016

(51) Int. Cl. G06Q 30/02; G06Q 30/06

(52) U.S. Cl. CPC G06Q 30/0222; G06Q 30/0605; G06Q 30/0214

(57) ABSTRACT

Systems and processes are disclosed that create a merchant's discounted offer, wherein the discounted offer is determined by applying a mathematical formula. The discounted offer is transmitted by the advertising agent to consumers via a communication network allowing consumers to purchase the discounted offer, which consists of two or more identical or dissimilar goods of varying prices and/or sizes. The advertising agent collects consumers' payments, retaining commissions before forwarding the remaining payments to the merchant. The advertising agent facilitates the consumers' purchases of the goods and restricts possession of the goods to two or more merchant visits.

### CLAIM TO PRIORITY

This application claims priority of U.S. provisional application Ser. No. 62/173,208, entitled “Apparatus And Process For Discounted Offers” and filed Jun. 9, 2016, the disclosure and drawings of which are incorporated herein in their entirety by reference.

### FIELD OF THE INVENTION

The present invention relates generally to an improvement of part of a process disclosed in U.S. Pat. No. 8,903,733 to Mason, U.S. Pat. No. 8,650,072 to Mason et al., U.S. Pat. No. 8,355,948 to Mason, and U.S. Pat. No. 8,301,495 to Mason, specifically the improvement eliminates a “tipping point” or minimum amount of purchases of discounted offers as unnecessary and subjective, and adds the improved process elements of (1) storing a merchant's discounted offer, wherein the discounted offer is determined by applying a mathematical formula; and (2) permitting the consumer to accept a predetermined price and amount of two or more identical price and size of units of the merchant's goods and/or services to be packaged into a discounted offer; and (3) restricting the consumer's taking possession of the merchant's discounted offer of goods and/or services to two or more visits per communication network and/or physical store location, wherein a visit is defined by the merchant as a unit of time. In addition, element (2) may be replaced with “permitting a consumer the opportunity to select a predetermined amount of any combination of two or more dissimilar prices and/or sizes of units of the merchant's goods and/or services to be packaged into a customizable merchant discounted offer.”

### BACKGROUND OF THE INVENTION

### 1. Reference Guide

The following terms as used herein and with respect to embodiments of the present invention include (but may not be limited to) the following descriptions:

Advertising Agent: The term “advertising agent” means a person authorized, by or on behalf of a merchant, for the limited purpose of advertising the merchant's goods and/or services to consumers, and the advertising agent's collection, disbursement and management of the consumer's purchase payments, and the settlement of commissions as authorized by the merchant to be paid to the advertising agent from the consumer's purchase payments.

Algorithm: The term “algorithm” means a procedure for solving a given type of mathematical problem.

And/or: The term “and/or” as used herein, and with respect to embodiments of the present invention, is used to indicate that one or more of the stated cases may occur. For example, the sentence “A consumer may select a fountain drink, coffee, and/or carbonated ready to drink beverage” indicates that although the person may have any of the three listed beverages, the choices are not exclusive; the person may have one, two, or all three of the choices.

Average ticket size: The term “average ticket size” means the amount of money that each consumer spends on average per merchant visit. The average ticket size is also commonly referred to as the average basket size. The consumer average ticket size for a convenience store is in the $7.50 range, compared to a grocery store in the $35 to $45 range. The consumer average ticket size can vary significantly by a merchant's goods and/or services offered for sale and the consumer's demographics.

Average Ticket Size of a Consumer Purchased Discounted Offer: The term “average ticket size of a consumer purchased discounted offer” means a consumer who purchased a merchant's discounted offer for goods and/or services, and during a visit to the merchant to take possession of said goods and/or services, and subsequently purchases additional goods and/or services during said visit to the merchant. For example, if a consumer purchased a discounted offer of 5 fountain drinks valued at a retail price of $1.50 per fountain drink, which was thereafter offered as a 50% off discounted offer of $7.50 for $3.75 redeemable over 5 visits, and during those five visits, the consumer purchased additional goods and/or services of $1.25, $2.50, $4.35, $9.25 and $4.15, the Average Ticket Size of a Consumer Purchased Discounted Offer would be $4.30.

Communication network: The term “communication network” means the exchange of information through an intranet, extranet, internetwork, internet, darknet, email, mobile phone and/or wireless device. The transmission of information can be accomplished with the use of wire or wireless technology, such as electrical cable, coaxial cable, twisted-pair copper cabling, optical fiber, radio waves, microwave, visible light and/or invisible light.

Consumer: The term “consumer” means a person who seeks or acquires by purchase or lease any goods or services.

Discounted Offer: The term “discounted offer” means a solicitation to sell goods and/or services at a reduced price that is less than the original retail price. For example, if a merchant has historically sold, under no compulsion to sell, fountain drinks at a $1.50 retail price, a solicitation to sell, under no compulsion to sell, fountain drinks at a $0.75 retail price would represent a discounted offer.

Discounted Offer Net Percentage to Merchant: The term “discounted offer net percentage to merchant” means the percentage of the retail price of one unit of goods and/or services that is received by the merchant after a consumer purchases the merchant's goods and/or services. For example, if a merchant's retail price is $1.00, and the merchant solicits a discounted offer of 50% off the $1.00 retail price, and the merchant pays an advertising agent 50% of the discounted offer price of $0.50 as a commission, the merchant would receive $0.25 after the consumer's purchase, or 25% of the original retail price. The Discounted Offer Net Percentage to Merchant would be 25%.

EBITA: The term “EBITA” means earnings before interest, taxes and amortization which refers to a company's earnings before the deduction of interest, taxes and amortization expenses.

Goods and/or Services: The term “goods” means tangible products bought or sold in the marketplace. The term “services” means work, labor, action or use that furthers some end or purpose: conduct or performance that assists or benefits someone or something: deeds useful or instrumental toward some object: an activity on behalf of one party by another, including services furnished in connection with the sale or repair of goods. The terms “goods” and/or “services” have the same meaning and are used interchangeably herein.

Gross Margin Percentage: The term “gross margin percentage” means the average percentage of a merchant's total sales derived from goods and/or services that is profit. For example, Alimentation Couche-Tard Inc., of Laval, Quebec, Canada, is the largest independent convenience store operator in North America with 6,241 store locations. Couche-Tard reported 2014 in-store total revenue for the U.S. of $4.8 billion, exclusive of fuel sales, realizing a gross margin percentage of 32.7%. It has been historically statistically accurate that financially successful convenience stores operate near a 33% gross margin percentage, as evidenced by Couche-Tard's actual financial reporting.

Markup Percentage: The term “markup percentage” means the percentage of total cost that is profit. For example, if a merchant's cost of a good is $0.25, and the merchant sells the good for $1.00, the markup percentage is three hundred percent (300%). The formula to convert markup percentage to unit gross margin percentage is 1−(1/(1/A+1)) where A equals markup percentage. The formula to convert unit gross margin percentage to markup percentage is (1/(1−B))−1 where B equals unit gross margin percentage.

Merchant: The term “merchant” means (1) a person, who buys and sells goods and/or services, or deals in goods of the kind, or (2) by his occupation holds himself out as having knowledge or skill peculiar to the practices involved in the transaction, or (3) by his occupation holds himself out as having knowledge or skill peculiar to the goods involved in the transaction, or (4) employs an intermediary who by his occupation holds himself out as having such knowledge or skill, and that knowledge or skill may be attributed to the person whose status is in question.

Person: The term “person” means an individual, corporation, business trust, estate, trust, partnership, limited liability company, association, joint venture, government, governmental subdivision, agency, or instrumentality, public corporation, or any other legal or commercial entity.

Purchase: The term “purchase” means taking by sale, lease, discount, negotiation, mortgage, pledge, lien, security interest, issue or reissue, gift, or any other voluntary transaction creating an interest in goods and/or services.

Retail Price: The word “retail price” means the price at which a willing consumer, under no compulsion to buy, has purchased and a willing merchant, under no compulsion to sell, has sold goods and/or services.

Terms: The word “terms” as used herein, may also encompass “conditions.”

Unit Gross Margin Percentage: The term “unit gross margin percentage” means the percentage of the retail price of one unit of goods and/or services that is profit. For example, if a merchant's cost of a good is $0.25, and the merchant sells the good at the retail price of $1.00, the unit gross margin percentage is seventy-five percent (75%). Other examples of unit gross margin percentage for popular convenience store units are close to: 5.1% for a gallon of fuel, 16.7% for a pack of cigarettes, 21.5% for a bottle of beer, 44.0% for a bag of potato chips, 54.5% for a candy bar, or 69.7% for a cup of coffee. The formula to convert unit gross margin percentage to markup percentage is (1/(1−A))−1 where A equals unit gross margin percentage.

Visit: The word “visit” means the beginning through ending time period that a consumer physically enters and exits a merchant's physical store location and/or electronically enters and exits a merchant's communication network.

### 2. Description of the Prior Art

In the late 1990's, the popularity of the Internet quickly transformed the purchase and sale of goods and/or services. Merchants desired a more cost effective process of instantaneously directly contacting consumers throughout the world, and consumers desired direct instantaneous contact with merchants to seek out goods and/or services. Prior to the Internet, merchants had the ability to directly reach large audiences through radio and/or television, and in limited quantities, consumers could directly respond to merchants through in-store visits or telephonically. However, as the popularity and use of the Internet increased, merchants and consumers had the ability to complete the entire purchase cycle of goods and/or services electronically through the Internet. The fundamental economic and longstanding commercial practice of purchasing goods and/or services prior to the Internet had been well established, however the application of these fundamental practices presented unique challenges on the Internet. A merchant could not perform his longstanding commercial business of selling goods and/or services by simply connecting to the Internet. One of the earliest fundamental problems of purchasing a good and/or service via the Internet was solved by Amazon.com, Inc., of Seattle, Wash., in U.S. Pat. No. 5,960,411, issued on Sep. 28, 1999 to Jeffrey P. Bezos, et al., which disclosed a method and system for placing an order to purchase an item via the Internet. Thereafter, Amazon.com continued to lead innovation for Internet transactions among merchants and consumers, generating $88.9 billion in revenue for 2014, placing Amazon.com in the top five list of largest merchants in the U.S.

Although Amazon.com solved problems associated with consumers purchasing goods and/or services from a merchant, the consumer's ability to negotiate pricing was no better than historically established practices prior to the Internet whereby merchants determined goods and/or services pricing relative to merchant competition for consumers. As the Internet continued to increase in consumer use, merchants continued to increase their presence, giving consumers thousands of merchants to shop for best available pricing utilizing greater efficiency and less cost than historically shopping merchant physical store locations. However, consumers could not directly influence pricing of goods and/or services until Mercata, Inc., of Bellevue, Wash., created an Internet system for co-op buying groups to form together to create purchasing power to achieve an economic bargain allowing consumers to directly influence pricing of goods and/or services, disclosed in U.S. Pat. No. 6,101,484, issued on Aug. 8, 2000 to Richard V. Halbert, et al. Mercata allowed consumers to indicate interest in a good and/or service, thereby driving the price downward as more consumers joined. In addition, Mercata held inventory giving it an advantage with inventory management, control and delivery. However, holding inventory also created a liability of unpredictable asset devaluation, added to the problem of consumers who initially indicated buying interest, thereafter losing interest because of the unpredictable and long wait times to lock in the consumer's purchase, and the fact that the group of consumer indication may not have been great enough to lower the price below where other merchants were selling their goods and/or services. Although Mercata raised over $90 million in financing in 1998, it was shut down in 2001 after depleting all its money.

With the continued problem of consumer's inability to directly influence pricing, another merchant set out to improve upon Mercata's business model. MobShop, Inc., of San Francisco, Calif., offered a similar “demand aggregation” process whereby merchants communicated conditional offers to potential consumers, allowing price discounts at certain volume commitments, disclosed in U.S. Pat. No. 6,269,343, issued on Jul. 31, 2001 to Matthew G. Pallakoff. Due to the nature of the merchant's conditional offers, consumers were incentivized to quickly recruit new potential consumers to increase commitments that would reduce everyone's price. In addition, MobShop's improved model did not hold inventory, saving money by not physically maintaining a warehouse and fulfilling the orders. With no inventory, MobShop removed inventory and supply chain risk, however, with no inventory control and management, Mob Shop was more prone to delays and damaged shipments. Along with this problem, Mob Shop also failed to resolve Mercata's problem of consumers abandoning buying interest because of unpredictable and long wait times to lock in their purchases, and the fact that the group of consumer indication may not have been great enough to lower the price below where other merchants were selling their goods and/or services. Mob Shop shut down in 2001. There were additional problems with Mercata and MobShop's solutions: consumers had no urgency to buy, there were too many choices with too many goods in each category that fragmented large group buying sizes, the process was too complicated, goods were almost exclusively the only option to purchase, which historically goods have the smallest profit margins, and there were long wait times to purchase and receive the goods.

In November 2008, Groupon, Inc., of Chicago, Ill., solved all of these previous problems of consumer directly influenced pricing through a system and method of mutually satisfying a consumer with a discounted offer, as disclosed in U.S. Pat. No. 8,903,733, issued on Dec. 2, 2014 to Andrew Mason, U.S. Pat. No. 8,650,072, issued on Feb. 11, 2014 to Andrew Mason et al., U.S. Pat. No. 8,355,948, issued on Jan. 15, 2013 to Andrew Mason, and U.S. Pat. No. 8,301,495, issued on Oct. 30, 2012 to Andrew Mason. Groupon's solutions were simple and well received by merchants and consumers: (1) the discounted offer price was negotiated by Groupon on behalf of consumers, which typically started at 50% off, or greater, (2) it was a simple process with an easy to navigate website, (3) there was no confusion or fragmentation of the buying group, one discounted offer per day, (4) there was immediate delivery, no waiting, the consumer could take possession of his goods and/or services the same day, or in some circumstances, instantly, (5) there was a strong call to action with a countdown to expiration to purchase the discounted offer, (6) there was less merchant pricing competition typically found with goods because the vast majority of the discounted offers were services, (7) Groupon held no inventory, (8) there were no upfront advertising costs for participating merchants, (9) merchants received a quick and often large influx of new consumers and increased sales, (10) merchants had no risk of wasted or inefficient advertising expenses, (11) merchants received measurable results, (12) merchants received upfront cash flow for future delivery of goods and/or services, and (13) consumers could freely choose to participate or decline deep discounted offers. Groupon's solutions were so well received by both consumers and merchants, that Groupon exceeded $1 billion in gross billings within two years and two months of launching, giving Groupon the distinction of being the fastest company to $1 billion in U.S. history, ultimately reaching $7.6 billion in gross billings three years later in 2014, with 260 million cumulative consumers within the Groupon communications network.

However, during the entire six year operating history of Groupon, the company has not produced a net profit, with its best performance for fiscal 2012 with a 4% EBITA net margin percentage. By comparison, the EBITA net margin percentage for the Dow Jones Industrial Average components of 30 of the largest corporations in the U.S., are between 7.5% to 60.8% with a historical average of 24.97%. While Groupon appears to have solved the consumers' problem of directly influencing pricing through Groupon's upfront negotiated 50% off deep discounted offers, the solution disrupted the historical merchant/consumer/advertising agent relationship for long-term fundamental financial balance. As a result, most well-known highly successful merchants could not afford to participate in Groupon's solution, and Groupon has had to lower its average advertising agent commissions from 50% to 35%, further decreasing Groupon's ability to earn a net profit. In addition, during the first three years of Groupon's launch, there were several hundred competitors using Groupon's business model in the U.S. alone, with at least 30 substantially well-funded competitors. Today, in 2015, there are less than five competitors using Groupon's solution, with the second largest competitor, LivingSocial, Inc., of Washington, D.C., near insolvency.

Initially the merchant, consumer, and advertising agent (Groupon) were equally satisfied with the results of Groupon's solution. Over time, the merchants discovered that recovery of their revenue lost from the merchant's discounted offer was not occurring. For example, if a merchant who owned a restaurant was solicited to offer a 50% off discounted offer, the merchant typically used the merchant's consumer average ticket size, which could be $40.00, as the discounted offer. The advertising agent would then transmit the discounted offer of a $40.00 value at 50% off through its communication network. The consumer would purchase the discounted offer for a price of $20.00, with the advertising agent receiving a 50/50 split commission of $10.00, and the remaining $10.00 transferred to the merchant. In simple terms, the merchant sold its goods and/or services of a $40.00 value for $10.00, realizing a $30.00 upfront loss. Most restaurants typically need to achieve a historical operating average of 33% gross margin profit, which translates as a $40.00 gross sale value of having $26.40 in cost. Using this example, the merchant will realize an actual loss of $26.40, less the $10.00 received from the consumer via the advertising agent, for a net loss of $16.40 for each discounted offer sold to a consumer. The merchant could break even if during the consumer's visit to the restaurant, the consumer purchased an additional $49.70 in goods, meaning the consumer's total purchase value would have been the original $40.00 value plus an additional $49.70 purchase for a total of $89.70. It is statistically improbable that in this example, the average consumer spends an average of $40.00 for a meal, likely indicating the point at which a consumer has satisfied his hunger, would then spend more than twice as much money, and gorge himself during one visit simply because the consumer saved $20.00 on his original purchase. Using a more realistic scenario, the merchant would be willing to risk a net loss of $16.40 with the hope that the consumer would be satisfied with the meal and service, and return for another visit paying full price, which a second visit at full price would allow the merchant to almost recover his loss from the first discounted offer visit. It would statistically take a third visit by the consumer paying full price for the merchant to fully recover its loss from the initial discounted offer.

Over time, successful merchants who had highly desirable goods and/or services were unwilling to accept essentially a 75% off value for their goods and/or services because the merchants were utilizing other more cost effective methods of acquiring consumers that were substantially less than Groupon's solution. The unwillingness and exodus of these historically successful merchants to utilize Groupon meant that the remaining merchants were of a more desperate nature, unsophisticated marketers, or newly started businesses. With a lower quality of merchants selling a lower quality of goods and/or services, the Groupon consumers began to lose interest in the selection of lower quality discounted offers, especially if a consumer purchased a discounted offer and was dissatisfied with the lower quality of goods and/or services. To help alleviate this downward spiral, Groupon began lowering its commission from an average of 50% down to 35%, which was helpful, however using the above example, rather than the merchant lose $16.40 per consumer, the merchant would only lose $13.40 per consumer and the consumer would need to spend an additional $40.61 at full price for the merchant to break even. Groupon's next attempt to alleviate the downward spiral was to present lower percentage discounted offers through its communication network, e.g. rather than set a goal of 50% off, 35% off or lower would be acceptable. Even with the lowered commission rate of 35%, and a discounted offer of 35% off, using the above example, the merchant would only lose $9.50 per consumer and the consumer would need to spend an additional $28.79 at full price for the merchant to break even. Groupon's solution statistically does not provide a long-term sustainable business model to allow a merchant to operate profitable. Although the merchant improved its financial position, the consumer was worse off choosing to purchase fewer lowered discounted offers of lower quality goods and/or services, and Groupon realized fewer commissions of lower amounts.

The initial problem of consumers directly influencing pricing had not been solved. Substituting superior goods and/or services with inferior goods and/or services with a corresponding price reduction does not achieve the desired goal of consumers directly influencing pricing. Consumers desire quality, brand named goods and/or services at deep discounted offers, however that goal is not achievable unless an algorithm is employed to calculate a merchant's probability of recovering its discounted offer loss, additionally referred to as a consumer acquisition costs. For example, it has been statistically satisfied that consumers desire 50% off discounted offers of reasonable quality goods and/or services as evidenced by Groupon's tremendous growth from $0.00 to $7.6 billion in only six years of operation. It has also been statistically satisfied that higher quality merchants with higher quality goods and/or services need competitive consumer acquisition costs, preferably recoverable in a single consumer visit. These desired goals can be accomplished by applying a mathematical formula to Groupon's prior art as explained above, creating an improved process. Throughout history, mathematical formulas have been utilized to improve known processes.

For example, U.S. Pat. No. 4,344,142, issued on Aug. 10, 1982 to James R. Diehr, II, and Theodore A. Lutton discloses an improvement to a process using mathematical formula executed by a computer controlled rubber processing feedback system. U.S. Pat. No. 4,766,539 issued on Aug. 23, 1988 to Henry L. Fox discloses a system of future weather forecasting based on a database of historical weather patterns. Fox uses an improvement to a process using mathematical formula executed by computer to forecast expected future trends and then is able to estimate insurance premiums for a client insuring against future weather conditions. U.S. Pat. No. 5,839,901, issued on Nov. 24, 1998 to Kip M. Karkanen discloses an improvement to a process using mathematical formula executed by a computer to provide a system of monitoring weight control and weight loss. U.S. Pat. Nos. 4,344,142, 4,766,539, and 5,839,901 are distinguishable from the present invention in that the present invention utilizes an improvement to a process using mathematical formula applied by a computer to a merchant's discounted offer of the merchant's goods and/or services that is presented through a communication network to a consumer who purchases in advance of receiving the goods and/or services and takes possession of the goods and/or services over two or more visits to the merchant's location.

### SUMMARY OF THE INVENTION

The primary object of the present invention solves the problem of consumers desiring to directly influence pricing by simplifying the process of aggregating a large group of consumers into a communications network who collectively through their participation have indicated an interest in discounted offers of the 50% off, or greater, retail price range. An advertising agent negotiates on behalf of the group of consumers by soliciting and/or allowing merchants to propose discounted offers of goods and/or services, and if accepted by the advertising agent, the discounted offer is transmitted through the communications network to the group of consumers for purchase.

The present invention relates generally to an apparatus and/or process comprising a processor and a memory having computer code stored therein, the computer code configured, when executed by the processor, to cause the apparatus to: (1) store a merchant's discounted offer, wherein the discounted offer is determined by applying a mathematical formula; and (2) determine a group of consumers to receive the merchant's discounted offer based on consumer information; and (3) transmit the merchant's discounted offer to the selected group of consumers via a communication network; and (4) permit the consumer to accept a predetermined price and amount of two or more identical price and size of units of the merchant's goods and/or services to be packaged into a discounted offer; and (5) receive consumer acceptance, process consumer payment in advance of taking possession of the goods and/or services, create a uniquely identifiable consumer receipt associated with the purchase of merchant's discounted offer; and (6) disburse consumer payment to merchant and advertising agent commission; and (7) restrict the consumer's taking possession of the merchant's discounted offer of goods and/or services to one unit redeemed per communication network and/or physical store visit, wherein a visit is defined by the merchant as a unit of time.

The present invention described in the previous paragraph, contemplates embodiment II by replacing numbered element “(4)” with “permitting a consumer the opportunity to select a predetermined amount of any combination of two or more dissimilar prices and/or sizes of units of the merchant's goods and/or services to be packaged into a customizable merchant discounted offer,” effectively permitting numerous dissimilar packaged units of discounted offers from one unique merchant. For example, a merchant could provide a list of predetermined discounted units of varying prices and/or sizes of coffee, fountain drinks, and/or carbonated ready to drink beverages packaged in 12 fluid ounce size aluminum cans. A consumer could select any combination of two or more minimum amount of units, e.g. three medium 16 fluid ounce size cups of coffee at $1.49 each, five large 24 fluid ounce cups of fountain drinks at $1.59 each, and seven carbonated ready to drink beverages at $1.19 each, for a total of fifteen units at a total price of $20.75 that could be offered at the discounted price of fifty percent off, or $10.38, wherein the 15 units at fifty percent off, or $10.38, would represent the merchant's discounted offer.

In addition, the present invention contemplates embodiment III, a loyalty program initiated in the merchant's physical store location and/or communication network that is also an electronic consumer acquisition process. This process relates generally to displaying the merchant's discounted offer at the merchant's physical store location and/or transmit the merchant's discounted offer through the merchant's communication network. For example, in the loyalty process, a consumer who is physically located at the merchant's physical store location, or merchant's communication network, such as a website or wireless image, may purchase the merchant's discounted goods and/or services through a network connected to the Internet or a wireless apparatus, wherein the sale of the merchant's discounted offer is contingent upon a consumer submitting information into an input device at the merchant's physical store location, or merchant's communication network.

Another object of the present invention is to provide consumers with a discount on goods and services, while providing the merchant no upfront cost for advertising for those goods and/or services.

Another object of the present invention is for the merchant to gain exposure to a new audience and to provide a vehicle, such as a website on the Internet, in which large numbers of consumers return to that particular vehicle to find out about new discounted offers.

Another object of the present invention is to provide the merchant with revenue from the sales of his goods and/or services prior a consumer taking possession of said goods and/or services.

Another object of the present invention is to provide a system and methods for increasing sales, and advertising the merchant's goods and/or services.

Another object of the present invention is to provide an incentive or loyalty program to promote or encourage specific actions or behavior of consumers while physically visiting a merchant's location.

Another object of the present invention is to provide a system and methods for matching consumers to relevant goods and/or services by obtaining information about consumers and matching those consumers to discounted offers that are more relevant or pertinent to that particular consumer and thus have a better chance of being accepted. This embodiment provides a more improved experience for the consumer and an improved quality of consumer being referred to the merchant, which is necessary for repeat business and greater profitability.

Another object of the present invention further contemplates the discounted offer being transmitted to the consumer's mobile telephone or wireless device. Applications for mobile telephone use can be created that would allow for searching, purchasing and selling the discounted offers for ease of use. Based on the GPS (Global Positioning System) functionality of various mobile telephones, discounted offers could be transmitted to consumers that are located near the merchant's physical location discounted offer could be redeemed. With this mobile application capability, a consumer can access the database of discounted offers (or be sent a message that there is a discounted offer nearby), search or be informed about a discounted offer on a mobile telephone, purchase the discounted offer, and walk into the merchant's physical store location and obtain the goods and/or services.

In addition, the present invention contemplates embodiment IV, an interactive solution that will allow the merchant to input data of a consumer's average ticket size, the merchant's overall gross margin average and the single unit gross profit margin of a merchant's goods and/or services, etc., to automatically calculate the probability of the merchant's discounted offer's success or failure rate, thus allowing the merchant to assess estimated risk and/or return on investment before launching its own discounted offer. In effect, the merchant has a discounted offer simulator to test various financial scenarios against historically collected data from actual previous discounted offers.

A further object of embodiment IV of this invention is to provide the merchant with a simple to use profit and loss forecasting tool to control the selection of the merchant's goods and/or services to be offered in a discounted offer more accurately and flexibly. The merchant selects his goods and/or services for a discounted offer program trying several goods and/or services scenarios and recording the data before committing to the merchant's most profitable discounted offer scenario. Thereafter the merchant uses said data and discounted offer scenario to optimally increase the merchant's success rate.

A further object of embodiment IV of this invention is to provide firstly, a database means for the merchant to plan and forecast data about his or her discounted offer goals and secondly said database means for the merchant to record his or her actual data and thirdly, said database means to report his or her profit/loss experience. Said database offers a more realistic, flexible and accurate planning, forecasting and control system than deterministic mathematical equations or classical accounting modeling.

A further object of embodiment IV of this invention is to provide an integrated system which consistently models and is sensitive to the merchant's discounted offer profit/loss process daily, weekly and monthly.

A further object of embodiment IV of this invention is to use a closed loop system to produce more accurate plans and forecasts of profit/loss discounted offers.

A further object of embodiment IV of this invention is to report and use the merchant's own discounted offer as a feedback measure of how the merchant's closed loop system is operating.

A further object of embodiment IV of this invention is to minimize random errors and accentuate longer term trends by using cumulative profit/loss of discounted offer data appropriately. Such data aggregation is only effective in a closed loop system and will accentuate long term trends allowing the merchant to determine the profit/loss of the discounted offers.

A further object of embodiment IV of this invention is to establish that a number greater than zero of the answer to the mathematical formula of ((RP×DONPM)−((1−UGMP)×RP))+(GMP×ATSCPDO), suggests a long term sustainable discounted offer that is cost effective for the merchant to execute. RP equals a merchant's goods and or/services Retail Price, DONPM equals Discounted Offer Net Percentage to Merchant, UGMP equals Unit Gross Margin Percentage, GMP equals Gross Margin Percentage, and ATSCPDO equals Average Ticket Size of a Consumer Purchased Discounted Offer.

A further object of embodiment IV of this invention is to consistently maintain the mathematical relationships of said mathematical formula and the return on investment.

A further object of embodiment IV of this invention is to permit the merchant to easily explore a variety of “what if” scenarios using said mathematical formula, permitting discounted offer planning optimization.

A further object of embodiment IV of this invention is to minimize the data collection effort so that common mobile devices, computers, and point of sale devices can be used effectively and efficiently to input data.

A further object of embodiment IV of this invention is to allow the merchant to enter and use his or her own Average Ticket Size of a Consumer Purchased Discounted Offer to override the calculated value, thereby possibly increasing forecast accuracy and credibility.

A further object of embodiment IV of this invention is to provide the merchant with sufficiently accurate data about his or her discounted offer experience to uncover the main reasons why the merchant is losing or not losing money on the discounted offer.

A further object of embodiment IV of this invention is to provide the merchant with effective solutions for the main reasons for not achieving profitability on his discounted offer, to allow the merchant the ability to make the proper decisions based on the right reasons.

A further object of embodiment IV of this invention is to use the computer and current computer modeling techniques to accomplish these objects.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1 illustrates a flow chart in accordance with embodiment I of the present invention, applying a mathematical formula to define a discounted offer of two or more goods and/or services, along with the restriction of taking possession of each goods and/or services over two or more visits; and

FIG. 2 illustrates a flow chart in accordance with embodiment II of the present invention, applying a mathematical formula to define a discounted offer of two or more goods and/or services, allowing the consumer to select from a group of dissimilar goods, sizes, and/or prices, along with the restriction of taking possession of each goods and/or services over two or more visits; and

FIG. 3 illustrates a portion of FIG. 2 flow chart in accordance with embodiment II of the present invention with a detailed view of FIG. 2, at 260, which allows the consumer to select from a group of dissimilar goods, sizes, and/or prices; and

FIG. 4 illustrates a flow chart in accordance with embodiment III of the present invention, applying a mathematical formula to define a discounted offer of two or more goods and/or services, allowing the merchant to select the discounted offer and transmit the discounted offer through the merchant's communication network, allowing the consumer to select from a group of similar or dissimilar goods, sizes, and/or prices, along with the restriction of taking possession of each goods and/or services over two or more visits; and

FIG. 5 illustrates an exemplary computer system according to the present invention, which will allow for the execution of embodiments I, II, III and IV, with embodiment IV allowing for the merchant to input data of a consumer's average ticket size, the merchant's overall gross margin average and the single unit gross profit margin of a merchant's goods and/or services to automatically calculate the probability of the merchant's discounted offer's success or failure rate.

### DETAILED DESCRIPTION OF THE ILLUSTRATIVE EMBODIMENT

The present invention encompasses various embodiments and aspects, some of which are specifically described and illustrated herein, including systems and processes that create a merchant's discounted offer, wherein the discounted offer is determined by applying a mathematical formula. The discounted offer is transmitted by the advertising agent to consumers via a communication network allowing consumers to purchase the discounted offer, which consists of two or more identical or dissimilar goods of varying prices and/or sizes. The advertising agent collects consumers' payments, retaining commissions before forwarding the remaining payments to the merchant. The advertising agent facilitates the consumers' purchases of the goods and restricts possession of the goods to two or more merchant visits.

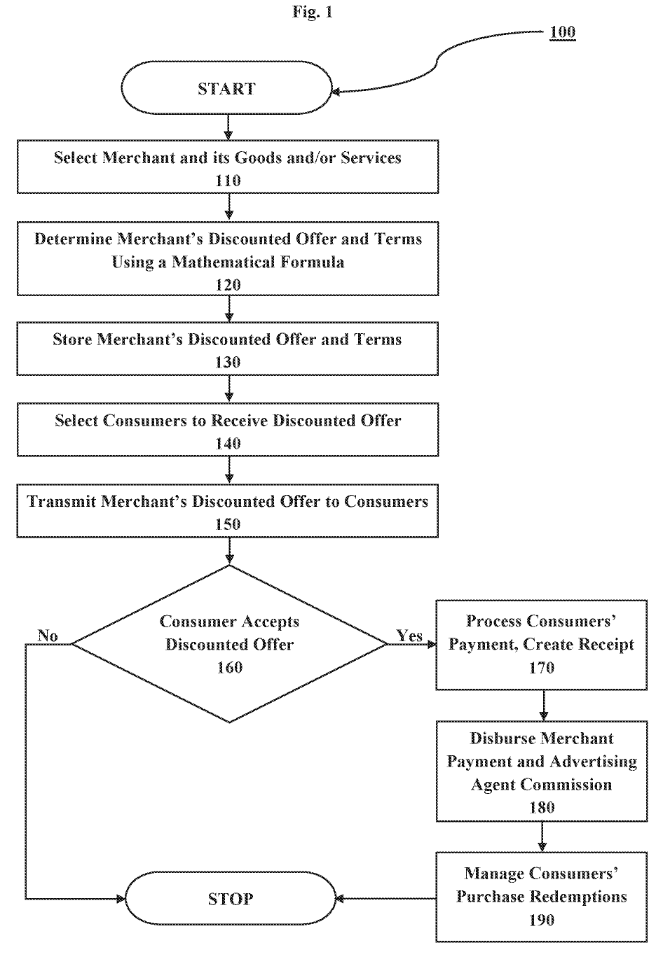

FIG. 1 illustrates a flow chart 100 in accordance with one embodiment of the present invention. As shown in FIG. 1, a merchant is selected at 110 for participation in the present invention. In addition, a merchant's goods and/or services are selected at 110. The present invention is applicable to a variety of goods and/or services and discounted offers. The merchant may be local, national or global in terms of the geography the merchant provides goods and/or services, and the merchant may be solicited for the system or may hear of the system and may approach the system's advertising agent without being solicited, although any variation is contemplated. Additionally, goods and/or services provided by the merchant are identified for a discounted offer at 120 by utilizing the mathematical formula ((RP×DONPM)−((1−UGMP)×RP))+(GMP×ATSCPDO), wherein RP equals a merchant's goods and or/services Retail Price, DONPM equals Discounted Offer Net Percentage to Merchant, UGMP equals Unit Gross Margin Percentage, GMP equals Gross Margin Percentage, and ATSCPDO equals Average Ticket Size of a Consumer Purchased Discounted Offer. The word “retail price” means the price at which a willing consumer, under no compulsion to buy, has purchased and a willing merchant, under no compulsion to sell, has sold goods and/or services. The term “discounted offer net percentage to merchant” means the percentage of the retail price of one unit of goods and/or services that is received by the merchant after a consumer purchases the merchant's goods and/or services. For example, if a merchant's retail price is $1.00, and the merchant solicits a discounted offer of 50% off the $1.00 retail price, and the merchant pays an advertising agent 50% of the discounted offer price of $0.50 as a commission, the merchant would receive $0.25 after the consumer's purchase, or 25% of the original retail price. The Discounted Offer Net Percentage to Merchant would be 25%. The term “unit gross margin percentage” means the percentage of the retail price of one unit of goods and/or services that is profit. For example, if a merchant's cost of a good is $0.45, and the merchant sells the good at the retail price of $1.00, the unit gross margin percentage is forty-five percent (45%). Other examples of unit gross margin percentage for popular convenience store categories are illustrated below in Table I and Table II:

TABLE I

| | 2014 | |
|---|---|---|
| | Gross | 2014 |
| | Margin | Markup |
| Category | Percentage | Percentage |
| Fuel | 5.1% | 5.4% |
| Cigarettes | 16.7% | 20.1% |
| Beer | 21.5% | 27.4% |
| Publications | 24.4% | 32.4% |
| Liquor | 27.2% | 37.4% |
| Wine | 30.4% | 43.8% |
| Packaged Bread | 32.9% | 48.9% |
| Fluid Milk Product | 34.0% | 51.5% |
| Other Tobacco | 35.1% | 54.2% |
| Packaged Sweet Snacks | 38.3% | 62.2% |
| Non-edible Grocery | 39.8% | 66.2% |
| Commissary/Packaged Sandwiches | 42.2% | 73.1% |
| Salty Snacks | 44.0% | 78.6% |
| General Merchandise | 45.3% | 82.8% |
| Packaged Beverages (non alcoholic) | 45.3% | 82.8% |

TABLE II

| | 2014 | |
|---|---|---|
| | Gross | 2014 |
| | Margin | Markup |
| Category | Percentage | Percentage |
| Other Dairy and Deli | 45.7% | 84.2% |
| Frozen Foods | 45.7% | 84.2% |
| Alternative Snacks | 47.7% | 91.4% |
| Edible Grocery | 48.5% | 94.3% |
| Perishable Grocery | 50.0% | 100.1% |
| Automotive Products | 52.2% | 109.0% |
| Packaged Ice Cream/Novelties | 52.8% | 112.0% |
| Candy | 54.5% | 119.7% |
| Health & Beauty Care | 59.2% | 144.9% |
| Cold Dispensed Beverages | 59.4% | 146.6% |
| Frozen Dispensed Beverages | 60.5% | 153.1% |
| Food Prepared On-Site | 63.0% | 170.0% |
| Hot Dispensed Beverages | 69.7% | 230.3% |
| Ice | 85.2% | 576.0% |

The term “gross margin percentage” means the average percentage of a merchant's total sales derived from goods and/or services that is profit. For example, Alimentation Couche-Tard Inc., of Laval, Quebec, Canada, is the largest independent convenience store operator in North America with 6,241 store locations. Couche-Tard reported 2014 in-store total revenue for the U.S. of $4.8 billion, exclusive of fuel sales, realizing a gross margin percentage of 32.7%. It has been historically statistically accurate that financially successful convenience stores operate near a 33% gross margin percentage, as evidenced by Couche-Tard's actual financial reporting. The term “average ticket size of a consumer purchased discounted offer” means a consumer who purchased a merchant's discounted offer for goods and/or services, and during a visit to the merchant to take possession of said goods and/or purchases, subsequently purchases additional goods and/or services during said visit to the merchant. For example, if a consumer purchased a discounted offer of 10 fountain drinks valued at a retail price of $1.00 per fountain drink, which was thereafter offered as a 50% off discounted offer of $10.00 for $5.00 redeemable over 10 visits, and during those ten visits, the consumer purchased additional goods and/or services of $1.15, $1.93, $1.46, $2.25, $1.15, $2.35, $3.05, $4.85, $1.55 and $2.75, the Average Ticket Size of a Consumer Purchased Discounted Offer would be $2.25.

By imputing the data from the above examples for the mathematical formula

((RP×DONPM)−((1−UGMP)×RP))+(GMP×ATSCPDO), whereby:
RP=$1.00
DONPM=25%
UGMP=45%
GMP=33%
ATSCPDO=$2.25

(($1.00×0.25)−((1−0.45)×$1.00))+(0.33×$2.25)=$0.45

The answer to the mathematical formula with the above input data is $0.45, which indicates a positive gross profit with a high probability of long term sustainability. In this example, the merchant would have no upfront advertising expense risks, and the merchant is statistically assured that even after paying the advertising agent a commission, and losing money from the 50% off discounted offer, overall the merchant will recover all losses concurrently with the consumer taking possession of his purchased goods and/or services. By comparison, successful historical customer acquisition methods typically recover costs over several months or years, and many never recover their customer acquisition costs.

By employing embodiment IV of the present invention, a merchant is prompted to enter five hypothetical data points in the above mathematical formula with the apparatus automatically calculating the output of a gain or loss, giving the merchant a logical probability of his hypothetical discounted offer's success or failure rate before taking a real risk in the marketplace. The above mathematical formula used in conjunction with said apparatus could be used as a discounted offer simulator wherein the merchant would experiment with dozens, or thousands of goods and/or services configured into a discounted offer. For example, if a merchant decided test a hypothetical discounted offer for 50% off a pack of $6.00 cigarettes using the mathematical formula of ((RP× DONPM)−((1−UGMP)×RP))+(GMP×ATSCPDO), the merchant would input four data variables to solve for ATSCPDO, thus (($6.00×25%)−((1−16.67%)×$6.00))+(33%×ATSCPDO), whereas ATSCPDO would equal $10.50, meaning the merchant would break even if on average, every consumer who purchased the 50% off cigarettes discounted offer also purchased an additional $10.50 worth of goods and/or services at the merchant's location. It is statistically unlikely, and historically improbable that a consumer would purchase on average an additional $10.50 worth of goods per visit when historical industry data evidences an average ticket size consisting of a pack of cigarettes to be in the $11.00 ticket size range. Given the assumption that the consumer has already pre-paid for his pack of cigarettes through the 50% off discounted offer, and is merely traveling to the merchant's store location to take possession of his pack of cigarettes, the $6.00 value of his pack of cigarettes would theoretically be removed from his statistical cigarette ticket size of $11.00, thus leaving theoretically $5.00 remaining that the consumer would statistically use for additional purchases, whereas in this example, the consumer would need to purchase at least an additional $10.50 worth of goods for the merchant to at least break even on the advertising agent commission and losses from the 50% off discounted offer. In summary, cigarettes are statistically a losing proposition for a 50% off discounted offer. In another example using a hypothetical discounted offer for 50% off $20.00 worth of fuel using the mathematical formula of ((RP×DONPM)−((1−UGMP)×RP))+(GMP×ATSCPDO), the merchant would input four data variables to solve for ATSCPDO, thus (($20.00×25%)−((1−5.01%)×$20.00))+(33%×ATSCPDO), whereas ATSCPDO would equal $42.00, meaning the merchant would break even if on average, every consumer who purchased the 50% off $20 worth of fuel discounted offer also purchased an additional $42.00 worth of goods at the merchant's location. It is statistically unlikely, and historically nearly impossible that a consumer would purchase on average an additional $42.50 worth of goods per visit when historical industry data evidences an average ticket size consisting of a fuel to be in the $7.50 ticket size range for additional in-side store purchases. A convenience store merchant utilizing a 50% off fuel discounted offer would result in one of the quickest maneuvers to bankruptcy.

After determining a statistically profitable discounted offer, at 130 the terms of the discounted offer are determined and include a discounted offer to be provided, images, illustrations, merchant location, consumer comments, solicitation period of the discounted offer, for example 24 hours, and maximum number, if any, of the goods and/or services the merchant is willing to offer, expiration date to take possession of the goods and/or services, or restrictions associated with the goods and/or services such as number of visits to complete taking possession of the goods and/or services. The next step at 140 determines a group of consumers to transmit the merchant's discounted offer to, based upon consumer information. Thereafter, the merchant's discounted offer is transmitted to the selected group of consumers via a communication network at 150. At 160 the consumer participates by accepting the discounted offer such as by “signing up” for the discounted offer on the communication network. “Signing up” may entail providing the name of the consumer; address of the consumer, and form of payment to purchase the discounted offer. Or the consumer may simply login to his account that was created from a previous sign up process. Although signing up is not necessary to purchase the discounted offers, a consumer could accept a discounted offer and provide payment information each time. Signing up provides the consumer a more efficient and convenient process for purchasing any future discounted offers. In addition, the consumer is permitted to accept a predetermined price, amount, or size of two or more identical units of the merchant's goods and/or services to be grouped into a discounted offer at 160. For example, a merchant may be soliciting a discounted offer consisting of all identical fountain drinks, or different fountain drink sizes and prices. The consumer may be limited to purchasing ten fountain drinks only, or any amount greater than one. The consumer may also be limited to an expiration date of 120 days to take possession of all fountain drinks purchased, or the consumer may be permitted to extend his expiration date to take possession for free, or for an additional fee to purchase additional time to extend the expiration date. After the consumer makes a decision to purchase, the advertising agent receives consumer acceptance, processes the consumer's payment, and creates a uniquely identifiable consumer receipt associated with the purchase of merchant's discounted offer at 170. The consumer's receipt could be an email, paper receipt, stored in electronic form on the consumer's mobile device, or stored in the advertising agent's database and retrievable at any time from the consumer's preferred output device. After acceptance of the consumer payment, the consumer is now free to visit the merchant to take possession of his pre-purchased goods and/or services. The consumer's method of payment is preferably an electronic funds transfer, e.g. credit card, debit card, electronic check, Paypal, etc. The consumer payment is processed, settled, and received by the advertising agent who deducts a previously agreed upon commission from the payment, and thereafter disburses all, or a part of, the remaining consumer payment to the merchant at 180. The advertising agent facilitates the management of the consumer's purchase and possession of the merchant's discounted offer by restricting the consumer's taking possession of the purchased goods and/or services in accordance with the terms of the merchant's discounted offer, with one such restriction being the consumer taking possession of the goods and/or services in two or more visits through the merchant's communication network and/or to the merchant's physical store visit, wherein a visit is defined by a unit of time at 190. The consumer could also take the printed receipt of the purchase, or other indication of purchase, to the merchant to take possession of the purchased goods and/or services. Alternatively, the list of consumers that purchased the merchant's goods and/or services in accordance with the discounted offer, could have the consumer's purchase information forwarded to the merchant for reconciliation. These two methods that validate the purchase can also be used in combination.

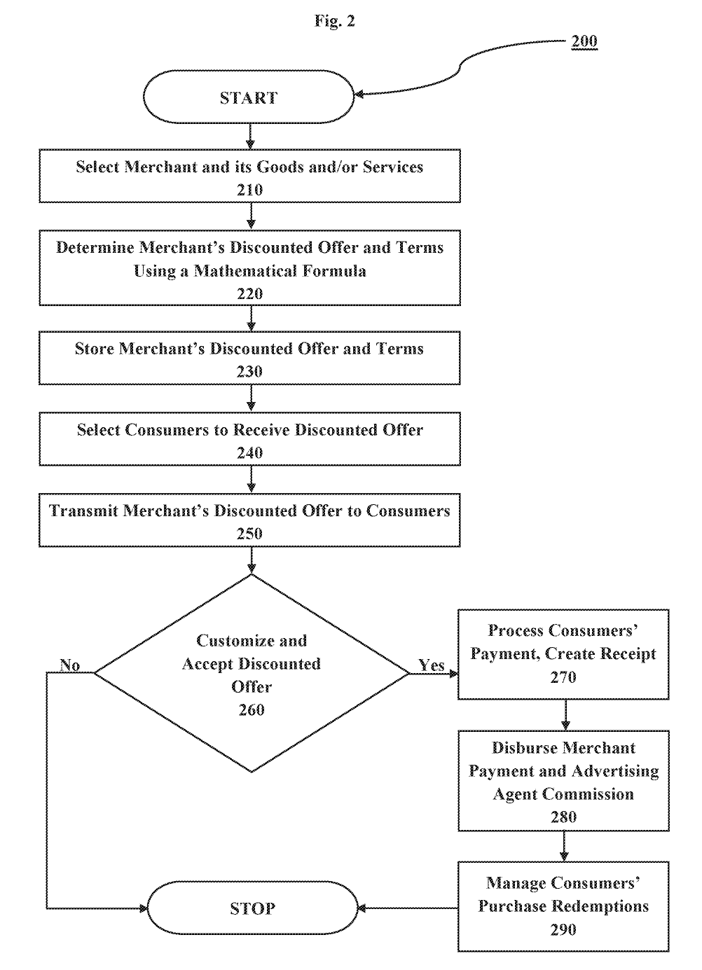

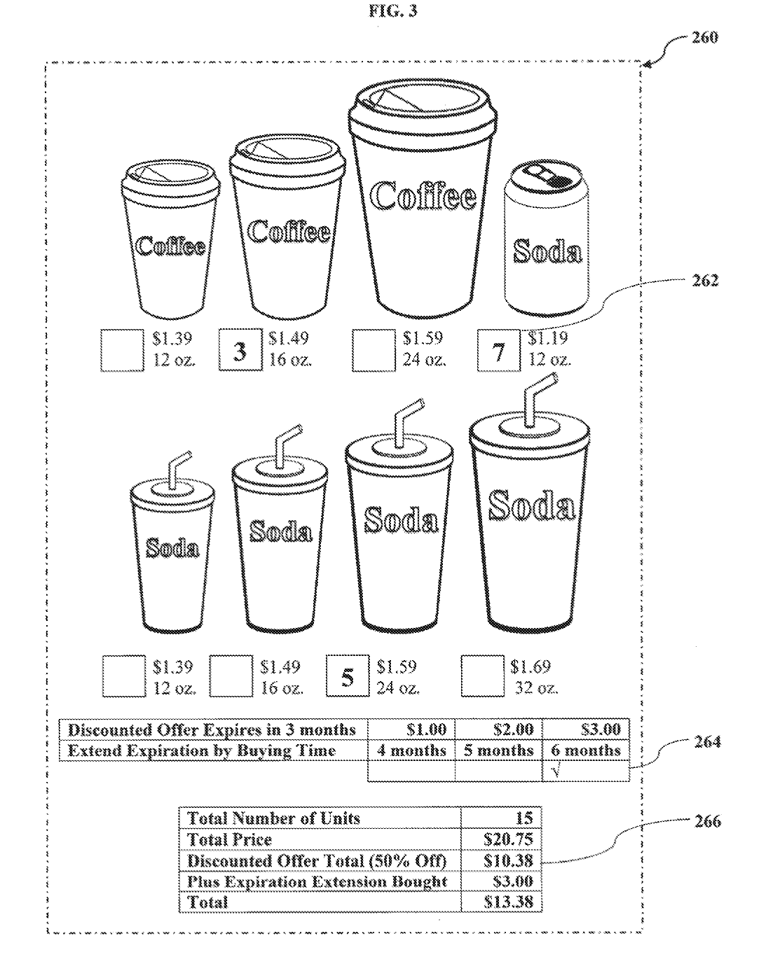

An alternative embodiment II of the present invention relates to FIG. 1, (see 160 in FIG. 1). In FIG. 2, all steps 210 through 290 are identical to FIG. 1 steps 110 through 190, except step 260 in FIG. 2 is different than step 160 in FIG. 1. Rather than be redundant in describing steps 110 through 190 of FIG. 1 again, for simplicity, only the differences of step 260 of FIG. 2 will be described below from step 160 of FIG. 1. FIG. 2 illustrates flow chart 200 in accordance with alternative embodiment II of the present invention. At 260 the consumer is permitted to select a predetermined amount of any combination of two or more dissimilar units with dissimilar prices and/or sizes of the merchant's goods and/or services to be grouped into a customizable discounted offer, effectively creating numerous combinations of dissimilar grouped units into a single discounted offer unique to each consumer. FIG. 3 is a blown up view of step 260 of FIG. 2 and provides a detailed example of step 260. FIG. 3 illustrates a view from a consumer's perspective of a selection from a list of predetermined units of varying prices and/or sizes of coffee, fountain drinks, and/or carbonated ready to drink beverages packaged in 12 fluid ounce size aluminum cans. A consumer could select any combination of two or more minimum amount of units, e.g. three medium 16 fluid ounce size cups of coffee at $1.49 each, five large 24 fluid ounce cups of fountain drinks at $1.59 each, and seven carbonated ready to drink beverages at $1.19 each at 262, for a total of fifteen units at a total price of $20.75 at 266, that could be offered at the discounted price of fifty percent (50%) off, or $10.38 at 266, wherein the 15 units at fifty percent (50%) off, or $10.38, would represent the merchant's discounted offer at 266. The consumer may be limited to purchasing two or more units, and a maximum number of units. The number of units and price of each unit selected is added together to allow the consumer to view a total price as units are added or subtracted at 266. The consumer may also be limited to an expiration date of three months to take possession of all units purchased, or the expiration date may automatically be extended to allow the consumer an adequate time period to take possession of the additional units selected, or the consumer may be permitted to extend his expiration date to take possession for an additional fee to purchase additional time to extend the expiration date at 264.

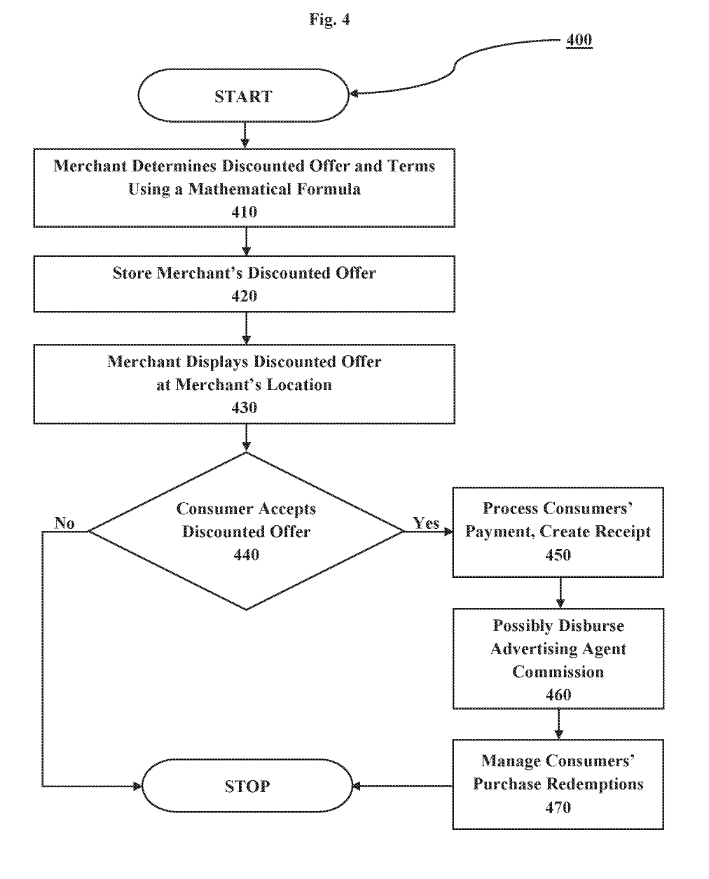

An alternative embodiment III of the present invention relates to a loyalty program used in conjunction with the discounted offer apparatus. FIG. 4 illustrates a flow chart 400 in accordance with embodiment III of the loyalty program of the present invention. Additionally, goods and/or services provided by the merchant are identified for a discounted offer at 410 by utilizing the mathematical formula ((RP×DONPM)−((1−UGMP)×RP))+(GMP×ATSCPDO), wherein RP equals a merchant's goods and or/services Retail Price, DONPM equals Discounted Offer Net Percentage to Merchant, UGMP equals Unit Gross Margin Percentage, GMP equals Gross Margin Percentage, and ATSCPDO equals Average Ticket Size of a Consumer Purchased Discounted Offer. The merchant may execute multiple scenarios of the above mathematical formula to create a discounted offer with a positive gross profit and a high probability of long term sustainability. By employing embodiment III of the present invention, a merchant is prompted to enter five hypothetical data points in the above mathematical formula with the apparatus automatically calculating the output of a gain or loss, giving the merchant a logical probability of his hypothetical discounted offer's success or failure rate before taking a real risk in the marketplace. The above mathematical formula used in conjunction with said apparatus could be used as a discounted offer simulator wherein the merchant would experiment with dozens, or thousands of goods and/or services configured into a discounted offer. After determining a statistically profitable discounted offer, at 420 the merchant's discounted offer is stored on the advertising agent's database. At 430, the merchant displays his discounted offer at the merchant's location. If the merchant's location is only accessed through a communication network, such as a website, images, illustrations, merchant location, consumer comments, solicitation period of the discounted offer, for example 24 hours, and maximum number, if any, of the goods and/or services the merchant is willing to offer, expiration date to take possession of the goods and/or services, or restrictions associated with the goods and/or services such as number of visits to complete taking possession of the goods and/or services are all displayed on the merchant's web site, advertising agent's web site, or third party authorized website. If the merchant's location is an actual physical store location, the merchant's discounted offer is displayed through point of sale signage or other in-store signage. At 440 the consumer participates by accepting the discounted offer such as by “signing up” for the discounted offer on the communication network or if at the merchant's physical store location, using a kiosk, tablet, mobile phone or other input device. “Signing up” may entail providing the name of the consumer; address of the consumer, and form of payment to purchase the discounted offer. Or the consumer may simply login to his account that was created from a previous sign up process. Although signing up is not necessary to purchase the discounted offer, a consumer could accept a discounted offer and provide payment information each time. Signing up provides the consumer a more efficient and convenient process for purchasing any future discounted offers. In addition, the consumer is permitted to accept a predetermined price, amount, or size of two or more identical or dissimilar units of the merchant's goods and/or services to be grouped into a discounted offer at 440. For example, a merchant may be soliciting a discounted offer consisting of all identical fountain drinks, or different fountain drinks, coffee, or candy sizes and prices. The consumer may be limited to purchasing ten fountain drinks only, or any combination of other goods, or any amount greater than one. The consumer may also be limited to an expiration date of 120 days to take possession of all fountain drinks purchased, or the consumer may be permitted to extend his expiration date to take possession for free, or for an additional fee to purchase additional time to extend the expiration date. After the consumer makes a decision to purchase, the advertising agent receives consumer acceptance, processes the consumer's payment, and creates a uniquely identifiable consumer receipt associated with the purchase of merchant's discounted offer at 450. The consumer's receipt could be an email, paper receipt, stored in electronic form on the consumer's mobile device, or stored in the advertising agent's database and retrievable at any time from the consumer's preferred output device. After acceptance of the consumer payment, the consumer is now free to immediately take possession of his purchased goods and/or services. The consumer's method of payment is preferably an electronic funds transfer, e.g. credit card, debit card, electronic check, Paypal, etc., or if at the merchant's physical location, cash is acceptable. The consumer payment is processed, settled, and received by the merchant who may or may not pay a commission to the advertising agent at 460. The advertising agent may waive any commissions from the merchant in exchange for the merchant essentially providing the advertising agent a free consumer that signed up in the advertising agent's database. The advertising agent facilitates the management of the consumer's purchase and possession of the merchant's discounted offer by restricting the consumer's taking possession of the purchased goods and/or services in accordance with the terms of the merchant's discounted offer, with one such restriction being the consumer taking possession of the goods and/or services in two or more visits through the merchant's communication network and/or to the merchant's physical store visit, wherein a visit is defined by a unit of time at 470. The consumer could also take the printed receipt of the purchase, or other indication of purchase, to the merchant to take possession of the purchased goods and/or services. Alternatively, the list of consumers that purchased the merchant's goods and/or services in accordance with the discounted offer, could have the consumer's purchase information forwarded to the merchant for reconciliation. These two methods that validate the purchase can also be used in combination.

Embodiment V of the present invention contemplates matching consumers to relevant goods and/or services in conjunction with the present invention described herein. By obtaining information about or from consumers, including their demographic profile, likes and dislikes, price range they are willing to spend, previous discounted offers they enjoyed or did not enjoy, etc. discounted offers can be made that are more relevant or pertinent to that particular consumer and thus have a better chance of being accepted. Information about the consumer can be obtained in numerous ways, including a consumer profile that is set up by the consumer or those that know the consumer, culled from previous discounted offers that the consumer accepted, from the consumer's ratings of those discounted offers, consumer questionnaires or surveys, a database about the consumers that was created from one or more of the above, or created elsewhere altogether. Once information about a particular consumer is known, the discounted offers that are forwarded to that consumer can be more relevant to that consumer and therefore more likely accepted. Further, embodiment V of the present invention contemplates better targeting of discounted offers to consumers and may offer one discounted offer to a group of consumers one day and a different discounted offer to a different group of consumers that same day. Also, based on information about the consumers, the present invention contemplates offering a particular discounted offer to one group of consumers one day and the same discounted offer to a different group of consumers a different day. As such, offering the same discounted offer to different consumers on different days allows the demand to be properly managed for the benefit of the merchant, which also reduces or avoids a poor user experience. For example, the experience of a consumer being prevented from taking possession of his goods and/or services because the convenience store ran out of stock. Numerous discounted offers may be offered to different or multiple groups at the same or different times. The present invention contemplates that based on historical action and certain consumer's responses to a discounted offer, additional consumers may be given the same discounted offer. For example, if a group of consumers is generated based on historical actions, and that group tends to accept discounted offers similar to another group of consumers (the second group being generated based on ratings of various discounted offers), then if the first group accepts a discounted offer by a certain percent (for example 15%), then the same discounted offer should be made to the second group of consumers. There is no limitation on the number of groups or even if certain consumers overlap into multiple groups (as long as they do not continue to receive the same discounted offer multiple times; unless that is their preference). A computer program or algorithm using various filters and subroutines can keep track of the consumer groups and which consumers have received which discounted offers. In this manner, a test group (or multiple test groups) can be generated to receive a discounted offer. If the test group accepts the discounted offer in certain quantities, the discounted offer is made to some or all of the other groups (or to everyone). If the test group does not respond favorably by accepting the discounted offer, the discounted offer may be dropped altogether.

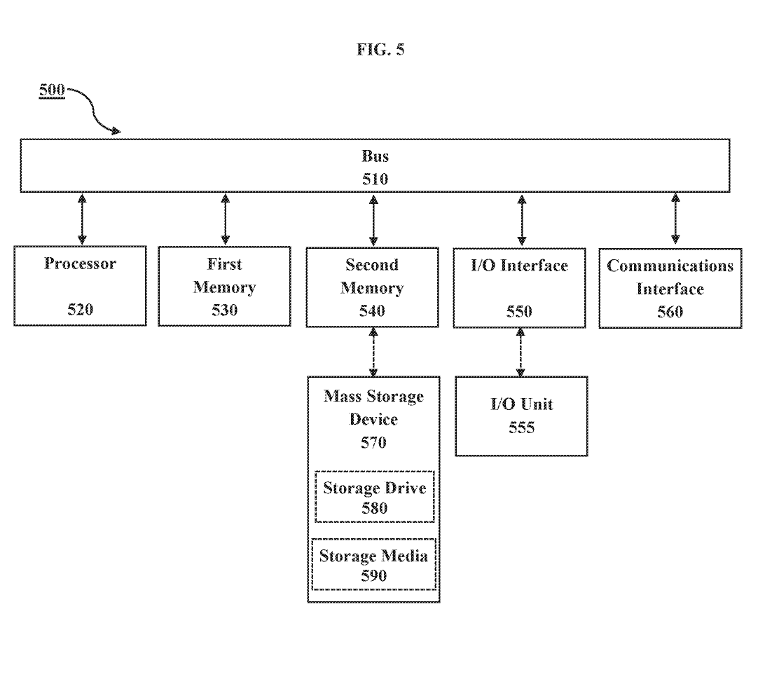

FIG. 5 illustrates an exemplary computer system 500, or network architecture, that may be used to implement the methods according to the present invention. One or more computer systems 500 may carry out the methods presented herein as computer code. One or more processors, such as processor 520, which may be a special purpose or a general-purpose processor is connected to a bus 510. As shown in FIG. 5, bus 510 connects the processor 520 to various other components of the computer system 500, but it is contemplated bus 510 may connect processor 520 to components (not shown) such as, sensors, and servomechanisms. It is also contemplated that bus 510 connects the processor 520 to other computer systems. Via the bus 510, the processor 520 can receive computer code. The term “computer code” includes, for example, programs, instructions, signals and/or data. The processor 520 executes computer code and may further send the computer code via the bus 510.

Computer system 500 may include one or more memories, such as first memory 530 and second memory 540. It is contemplated that the first memory 530, secondary memory 540, or a combination thereof function as a computer usable storage medium to store and/or access computer code. The first memory 530 and second memory 540 may be, for example, random access memory (RAM), read-only memory (ROM), a mass storage device, or any combination thereof.

As shown in FIG. 5, one embodiment of second memory 540 is a mass storage device 570, although it is contemplated that first memory 530 may be the mass storage device. The mass storage device 570 comprises a storage drive 580 and a storage media 590. It is contemplated the storage media 590 may or may not be removable from the storage drive 580. Mass storage devices 570 with storage media 590 that are removable, otherwise referred to as removable storage media, allow computer code to be transferred to and/or from the computer system 500.

A mass storage device 570 may include, for example, a Compact Disc Read-Only Memory (“CDROM”), ZIP storage device, tape storage device, magnetic storage device, optical storage device, Micro-Electro-Mechanical Systems (“MEMS”), nanotechnological storage device, floppy storage device, hard disk device. Mass storage device 570 also includes program cartridges and cartridge interfaces (such as that found in video game devices), removable memory chips (such as an EPROM, or PROM) and associated sockets.

The computer system 500 may further or alternatively include other means for computer code to be loaded into or removed from the computer system 500, for example, input/output (“I/O”) interface 550 and/or communications interface 560. Both the I/O interface 550 and the communications interface 560 allow computer code to be transferred between the computer system 500 and external devices including other computer systems. This transfer may be bi-directional or omni-direction to or from the computer system 500.

Computer code transferred by the I/O interface 550 and the communications interface 560 are typically in the form of signals, which may be electronic, electromagnetic, optical, or other signals capable of being sent and/or received by the interfaces. These signals may be transmitted via a variety of modes including, but not limited to, wire or cable, fiber optics, a phone line, a cellular phone link, infrared (“IR”), and radio frequency (“RE”) link.

The I/O interface 550 may be any connection, wired or wireless, that allows the transfer of computer code. An I/O interface 550 includes, for example, an analog or digital audio connection, digital video interface (“DVI”), video graphics adapter (“VGA”), musical instrument digital interface (“MIDI”), parallel connection, PS/2 connection, serial connection, universal serial bus connection (“USB”), IEEE1395 connection, PCMCIA slot and card. In certain embodiments the I/O interface connects to an I/O unit 555 such as a user interface, monitor, speaker, printer, touch screen display, to name a few.

The communications interface 560 is also any connection that allows the transfer of computer code. Communication interfaces include, but are not limited to, a modem, network interface (such as an Ethernet card), wired or wireless systems (such as Wi-Fi, Bluetooth, and IR), local area networks, wide area networks, intranets, darknets, etc.

The invention is also directed to computer products, otherwise referred to as computer program products, to provide software that includes computer code to the computer system 500. Processor 520 executes the computer code in order to implement the methods of the present invention. As an example, the methods according to the present invention may be implemented using software that includes the computer code, wherein the software is loaded into the computer system 500 using a memory 530, 540 such as the mass storage drive 570, or through an I/O interface 550, communications interface 560, or any other interface with the computer system 500. The computer code in conjunction with the computer system 500 described herein may perform any one of, or any combination of, the steps of any of the methods presented herein. It is also contemplated that, the methods according to the present invention may be performed automatically, or may be invoked by some form of manual intervention.

The computer system 500, or network architecture, of FIG. 5 is provided only for purposes of illustration, such that the present invention is not limited to this specific embodiment. It is appreciated that a person skilled in the relevant art knows how to program and implement the invention using any computer system or network architecture.

The described embodiments are to be considered in all respects only as illustrative and not restrictive, and the scope of the invention is, therefore, indicated by the appended claims rather than by the foregoing description. Those of skill in the art will recognize changes, substitutions and other modifications that will nonetheless come within the scope of the invention and range of the claims.

What is claimed is:

1. An apparatus comprising a processor and a memory having computer code stored therein, the computer code configured, when executed by the processor, to cause the apparatus to: (1) store a merchant's discounted offer, wherein the discounted offer is determined by applying a mathematical formula; and (2) determine a group of consumers to receive the merchant's discounted offer based on consumer information; and (3) transmit the merchant's discounted offer to the selected group of consumers via a communication network; and (4) permit the consumer to accept a predetermined price and amount of two or more identical price and size of units of the merchant's goods and/or services to be packaged into a discounted offer; and (5) receive consumer acceptance, process consumer payment in advance of taking possession of the goods and/or services, create a uniquely identifiable consumer receipt associated with the purchase of merchant's discounted offer; and (6) disburse consumer payment to merchant and advertising agent commission; and (7) restrict the consumer's taking possession of the merchant's discounted offer of goods and/or services to one unit redeemed per communication network and/or physical store visit, wherein a visit is defined by the merchant as a unit of time.

2. The apparatus of claim 1, wherein said mathematical formula is ((RP×DONPM)−((1−UGMP)×RP))+(GMP×ATSCPDO), wherein RP equals a merchant's goods and or/services Retail price, DONPM equals Discounted Offer Net Percentage to Merchant, UGMP equals Unit Gross Margin Percentage, GMP equals Gross Margin Percentage, and ATSCPDO equals Average Ticket Size of a Consumer Purchased Discounted Offer.

3. The apparatus of claim 1, wherein said good and/or service is distributed by said merchant.

4. The apparatus of claim 1, wherein said good and/or service is provided by said merchant.

5. The apparatus of claim 1, wherein said discounted offer price is reduced from said original retail price by an absolute amount.

6. The apparatus of claim 1, wherein said discounted offer price is reduced from said original retail price by a percentage amount.

7. The apparatus of claim 1, wherein said merchant is not charged for said transmitting discounted offer via the advertising agent's communication network.

8. The apparatus of claim 1, wherein said discounted offer includes the description of the good and/or service being offered at said discounted offer price.

9. The apparatus of claim 1, wherein said discounted offer includes a picture of the good and/or service being offered at said discounted offer price.

10. The apparatus of claim 1, wherein said discounted offer includes an indication of the amount saved based on the discounted offer price.

11. The apparatus of claim 1, wherein said discounted offer includes an indication of the percentage saved based on the discounted offer price.

12. The apparatus of claim 1, wherein said visit is a predetermined unit of time as one day.

13. The apparatus of claim 1, wherein said visit is a predetermined unit of time as less than one day.

14. The apparatus of claim 1, wherein said visit is a predetermined unit of time as greater than one day.

15. The apparatus of claim 1, wherein only one discounted offer is transmitted to a consumer per day.

16. The apparatus of claim 1, wherein only one discounted offer is presented per day in a specified geographic location.

17. The apparatus of claim 1, wherein said receiving acceptances of the discounted offer price for the good and/or service over the network comprises obtaining a response from a potential consumer that the consumer accepts the offer for the good and/or service.

18. The apparatus of claim 1, wherein the computer code is further configured, when executed by the apparatus, to cause the apparatus to determine a discounted offer duration.

19. The apparatus of claim 1, wherein the computer code is further configured, when executed by the apparatus, to cause the apparatus to store consumer information to a consumer profile based on the received consumer acceptances.

20. The apparatus of claim 1, wherein consumer acceptance includes accepting multiple discounted offers.

21. The apparatus of claim 1, wherein consumer acceptance includes providing comments after accepting a discounted offer and redeeming said discounted offer at the merchant.

22. The apparatus of claim 1, wherein consumer acceptance includes communicating with other consumers about a discounted offer.

23. The apparatus of claim 1, wherein said transmitting of said discounted offer through said communications network comprises presenting the discounted offer to said potential consumers through the display on the potential consumer's computer.

24. The apparatus of claim 1, wherein said displaying of said discounted offer through said communications network comprises presenting the discounted offer to said potential consumers through the display on the potential consumer's wireless device.

25. The apparatus of claim 24, wherein said wireless device comprises a cellular telephone, personal digital assistant, Wi-Fi connected device, or laptop computer.

26. The apparatus of claim 1, wherein consumer acceptance includes accepting a discounted offer and redeeming that discounted offer at the merchant.

27. The apparatus of claim 26, wherein said consumer acceptance includes obtaining a method of payment from said consumer for the good and/or service.

28. The apparatus of claim 27, wherein said method of payment comprises credit or debit card information, checking or savings account information, or information about a Paypal account.

29. An apparatus comprising a processor and a memory having computer code stored therein, the computer code configured, when executed by the processor, to cause the apparatus to: (1) store a merchant's discounted offer, wherein the discounted offer is determined by applying a mathematical formula; and (2) determine a group of consumers to receive the merchant's discounted offer based on consumer information; and (3) transmit the merchant's discounted offer to the selected group of consumers via a communication network; and (4) permit a consumer the opportunity to select a predetermined amount of any combination of two or more dissimilar prices and/or sizes of units of the merchant's goods and/or services to be packaged into a customizable merchant discounted offer; and (5) receive consumer acceptance, process consumer payment in advance of taking possession of the goods and/or services, create a uniquely identifiable consumer receipt associated with the purchase of merchant's discounted offer; and (6) disburse consumer payment to merchant and advertising agent commission; and (7) restrict the consumer's taking possession of the merchant's discounted offer of goods and/or services to one unit redeemed per communication network and/or physical store visit, wherein a visit is defined by the merchant as a unit of time.

30. An apparatus comprising a processor and a memory having computer code stored therein, the computer code configured, when executed by the processor, to cause the apparatus to: (1) store a merchant's discounted offer, wherein the discounted offer is determined by applying a mathematical formula; and (2) display the merchant's discounted offer at the merchant's physical store location and/or transmit the merchant's discounted offer through the merchant's communication network; and (3) permit the consumer to accept a predetermined price and amount of two or more identical or dissimilar price and size of units of the merchant's goods and/or services to be packaged into a discounted offer; and (4) receive consumer acceptance, process consumer payment in advance of taking possession of the goods and/or services, create a uniquely identifiable consumer receipt associated with the purchase of merchant's discounted offer; and (5) disburse consumer payment to merchant and advertising agent commission; and (6) restrict the consumer's taking possession of the merchant's discounted offer of goods and/or services to one unit redeemed per communication network and/or physical store visit, wherein a visit is defined by the merchant as a unit of time.

31. An apparatus comprising a processor and a memory having computer code stored therein, the computer code configured, when executed by the processor, to cause the apparatus to: (1) store a merchant's discounted offer; and (2) determine a group of consumers to receive the merchant's discounted offer based on consumer information; and (3) transmit the merchant's discounted offer to the selected group of consumers via a communication network; and (4) permit a consumer the opportunity to select a predetermined amount of any combination of two or more similar and/or dissimilar prices and/or sizes of units of the merchant's goods and/or services to be packaged into a customizable merchant discounted offer; and (5) receive consumer acceptance, process consumer payment in advance of taking possession of the goods and/or services, create a uniquely identifiable consumer receipt associated with the purchase of merchant's discounted offer; and (6) disburse consumer payment to merchant and advertising agent commission; and (7) restrict the consumer's taking possession of the merchant's discounted offer of goods and/or services to two or more communication network and/or physical store visits, wherein a visit is defined by the merchant as a unit of time.

32. An apparatus comprising a processor and a memory having computer code stored therein, the computer code configured, when executed by the processor, to cause the apparatus to: (1) allow the merchant to input data of a consumer's average ticket size, the merchant's overall gross margin average and the single unit gross profit margin of a merchant's goods and/or services to automatically calculate the probability of the merchant's discounted offer's success/failure rate; and (2) store the merchant's discounted offer; and (3) determine a group of consumers to receive the merchant's discounted offer based on consumer information; and (4) transmit the merchant's discounted offer to the selected group of consumers via a communication network; and (5) permit the consumer to accept a predetermined price and amount of two or more identical price and size of units, or dissimilar unit, price, and amount, of the merchant's goods and/or services to be packaged into a discounted offer; and (6) receive consumer acceptance, process consumer payment in advance of taking possession of the goods and/or services, create a uniquely identifiable consumer receipt associated with the purchase of merchant's discounted offer; and (7) disburse consumer payment to merchant and advertising agent commission; and (8) restrict the consumer's taking possession of the merchant's discounted offer of goods and/or services to one unit redeemed per communication network and/or physical store visit, wherein a visit is defined by the merchant as a unit of time.

33. A computer program product comprising a non-transitory computer usable storage medium storing computer code stored that, when executed by an apparatus, causes the apparatus to: (1) store a merchant's discounted offer, wherein the discounted offer is determined by applying a mathematical formula; and (2) determine a group of consumers to receive the merchant's discounted offer based on consumer information; and (3) transmit the merchant's discounted offer to the selected group of consumers via a communication network; and (4) permit the consumer to accept a predetermined price and amount of two or more identical price and size of units of the merchant's goods and/or services to be packaged into a discounted offer; and (5) receive consumer acceptance, process consumer payment in advance of taking possession of the goods and/or services, create a uniquely identifiable consumer receipt associated with the purchase of merchant's discounted offer; and (6) disburse consumer payment to merchant and advertising agent commission; and (7) restrict the consumer's taking possession of the merchant's discounted offer of goods and/or services to one unit redeemed per communication network and/or physical store visit, wherein a visit is defined by the merchant as a unit of time.
